(19) United States
(12) Patent Application Publication
(10) Pub. No.: US 2023/0249422 A1
(43) Pub. Date: Aug. 10, 2023

(54) DEVICE FOR PROCESSING FIBRE-REINFORCED PLASTIC

(71) Applicant: BROETJE-AUTOMATION GMBH, Rastede (DE)

(72) Inventors: Christoph Cornelius, Butjadingen (DE); Simon Memmen, Wangerland (DE)

(21) Appl. No.: 18/007,970

(22) PCT Filed: Mar. 12, 2021
(86) PCT No.: PCT/EP2021/056313

§ 371 Date: Dec. 2, 2022

(30) Foreign Application Priority Data
Jun. 4, 2020 (DE) 10 2020 114 894.1

(51) Int. Cl. B29C 70/56; B64F 5/10; B29C 70/50; B29C 70/54

(52) U.S. Cl. CPC B29C 70/56; B64F 5/10; B29C 70/504; B29C 70/545; B29C 2793/009

(57) ABSTRACT

The invention relates to a device for processing fibre-reinforced plastic, more particularly for producing structural components for aircraft (2) or preforms for same, said device comprising at least two functional units (4), the functional units (4) comprising at least one feed unit (5) for feeding a laid fibre scrim web (6) and a processing unit (8) for processing the laid fibre scrim web (6), with a primary drive (9) for driving the laid fibre scrim web (6), with a control arrangement (10) for open-loop or closed-loop control of the primary drive (9). According to the invention the device (3) has at least one secondary drive (11) for driving the laid fibre scrim web (6), the device (3) has a force-measuring device (12) associated with the secondary drive (11), with a force sensor (13) for measuring a web tension in the laid fibre scrim web (6) by means of the control arrangement (10), the control arrangement (10) controls the secondary drive (11) in a feedback control routine, the feedback control routine comprises a secondary feedback circuit (14) to control the secondary drive (11), the control arrangement (10) in the feedback control routine supplies the web tension measured by the force-measuring device (12) associated with the secondary drive (11) as an actual value (15) to the secondary feedback circuit (14) and determines and sets a controlled variable (16) for the secondary drive (11) on the basis of the web tension in the secondary feedback circuit (14).

The invention relates to a device for processing fiber-reinforced reinforced plastic, according to the preamble of claim 1, to a device for processing layer constructions, according to the preamble of claim 13, to the use of a device of this type, according to claim 14, and to a method for controlling a device of this type, according to claim 15.

The use of fiber-reinforced plastics nowadays is rapidly increasing. This applies in particular to glass fiber-reinforced and carbon fiber-reinforced plastics, the use of the latter increasing by virtue of the ever increasing demand for lightweight construction solutions. This applies in particular to the aerospace industry and to the automotive industry.

However, the automated production of glass fiber-reinforced and carbon fiber-reinforced components (GFRP and CFRP components) still represents a major challenge. Manual processing thus still occupies a large proportion of the production.

In the known device for processing fiber-reinforced plastic (DE 10 2014 002 950 A1), from which the invention proceeds, various functional operations for treating a web of a fiber scrim of fiber-reinforced plastic are bundled in one device. The web is conveyed through the device by a single drive. As a result of a single drive being used, tensions and at worst distortions in the fiber scrim web may arise.

The invention is based on the object of designing and refining the known device in such a manner that the drive concept of said device is improved, in particular so as to achieve more uniform conveying of the fiber scrim web.

The above object in a device according to the preamble of claim 1 is achieved by the features of the characterizing part of claim 1.

Essential is the fundamental concept that a secondary drive which likewise drives the fiber scrim web can be provided besides the primary drive. If this secondary drive is combined with a force sensor, feedback-controlling of the secondary drive can be implemented, said feedback-controlling enabling stable and uniform conveying of the fiber scrim web even in the event of variations between the drives, such as can be created by manual interventions in the device, for example.

It is proposed in detail that the device has at least one secondary drive for driving the fiber scrim web; that the device has a force-measuring assembly, assigned to the secondary drive, having a force sensor for measuring a web tension of the fiber scrim web by means of the control assembly; that the control assembly actuates the secondary drive in a feedback-control routine; that the feedback-control routine comprises a secondary feedback-control loop for feedback-controlling the secondary drive; that the control assembly in the feedback-control routine feeds the web tension measured by the force-measuring assembly assigned to the secondary drive as an actual value to the secondary feedback-control loop and, based on the web tension in the secondary feedback-control loop, determines and sets a correcting variable, in particular the rotating speed or the torque, of the secondary drive.

In one design embodiment according to claim 2, the primary drive is likewise assigned a force sensor and a feedback-control loop which also feedback-controls the primary drive.

Provided in one preferred design embodiment according claim 3 is even at least one further secondary drive, which is likewise feedback-controlled. In this way, the web tension of the fiber scrim web can be further optimized by way of the device, in particular at critical locations in the processing of the fiber scrim web.

Claim 4 sets forth functional units which are preferably present. Claims 5 and 6 set forth preferred design embodiments of the fiber scrim web and the processing of the latter, in particular in terms of the connection of layers of the fiber scrim web. In the event of variations in the web tension, mutual delamination of the layers can arise in particular in the case of layer constructions from carbon fiber-reinforced plastics (CFRP) and glass fiber-reinforced plastic (GFRP), the layers thereof during processing usually being only partially connected to one another. This requires expensive manual rectification work or leads to rejects.

Preferred disposals of the drives are the subject matter of claim 7. Claim 8 sets forth preferred design embodiments of the drives, wherein in one particularly preferred design embodiment a drive roller of a drive has a casing of an elastic material, in particular a foam material, by means of which thickness fluctuations of the fiber scrim web can be compensated in a conveying direction as also in a direction transverse thereto. This also leads to a more uniform distribution of forces within the fiber scrim web.

Claim 9 relates to the disposal of the force sensor in relation to the assigned drive. The force sensor here is preferably disposed close to the drive, so as to be behind the drive.

Claims 10 and 11 relate to particularly preferred design embodiments of the force-measuring assembly. According to claim 10, the latter can have a deflection roller on which the fiber scrim web is deflected. This deflection roller can be flexibly mounted. According to claim 11, the force sensor can measure a deflection of the deflection roller, said deflection being a function of the web tension. It is preferable here for only a single force sensor to be provided, the latter being disposed so as to be approximately central on the deflection roller. Owing to the relatively high stability, in particular in the case of carbon fiber-reinforced and glass fiber-reinforced plastic, a single force sensor may be sufficient for feedback-controlling the drive, without comparatively major variations arising transversely to the conveying direction of the fiber scrim web.

According to claim 12, the drives are preferably mutually synchronized in a superordinate synchronization routine, as a result of which the web tension can be uniformly feedback-controlled along the device.

According to a further teaching according to claim 13, which is of independent relevance, a device for processing layer constructions is claimed. It has been recognized here that the proposed force-measuring assembly can in principle also be relevant for other materials. The device here can otherwise be designed so as to be substantially similar to the device of the first teaching. Reference may be made to all explanations pertaining to the device of the first teaching.

According to a further teaching according to claim 14, which is likewise of independent relevance, the use of a device of the first or of the second teaching for processing fiber-reinforced plastic is claimed. Reference may be made to all explanations pertaining to the devices according to the proposal.

According to a further teaching according to claim 15, which is likewise of independent relevance, a method for controlling a device according to the proposal is claimed. Reference may be made to all explanations pertaining to the devices according to the proposal, and to the use of said devices.

The invention will be explained in more detail hereunder by means of a drawing which illustrates merely one exemplary embodiment. In the drawing

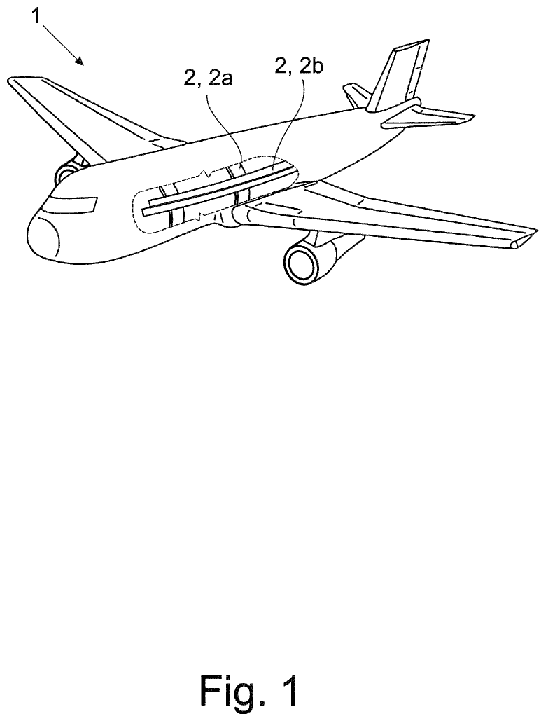

FIG. 1 shows an aircraft having structural aircraft components which can be produced according to the proposal;

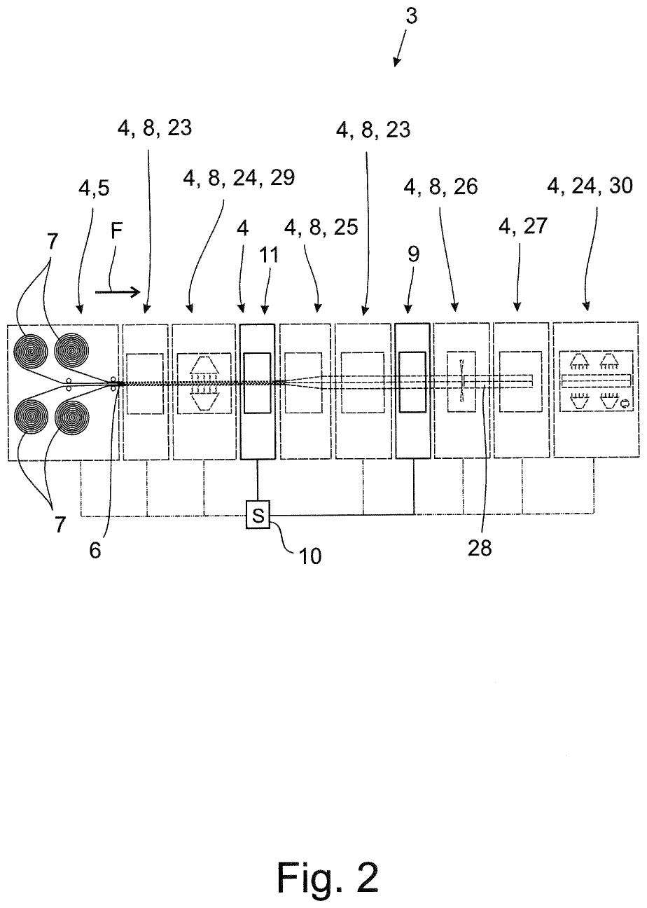

FIG. 2 shows a schematic illustration of a device according to the proposal;

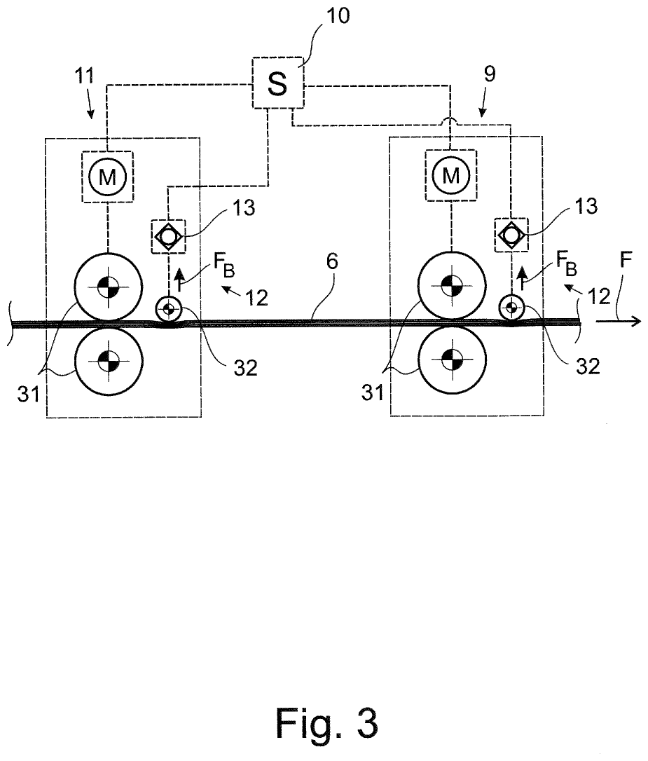

FIG. 3 schematically shows a potential drive concept of the device according to the proposal;

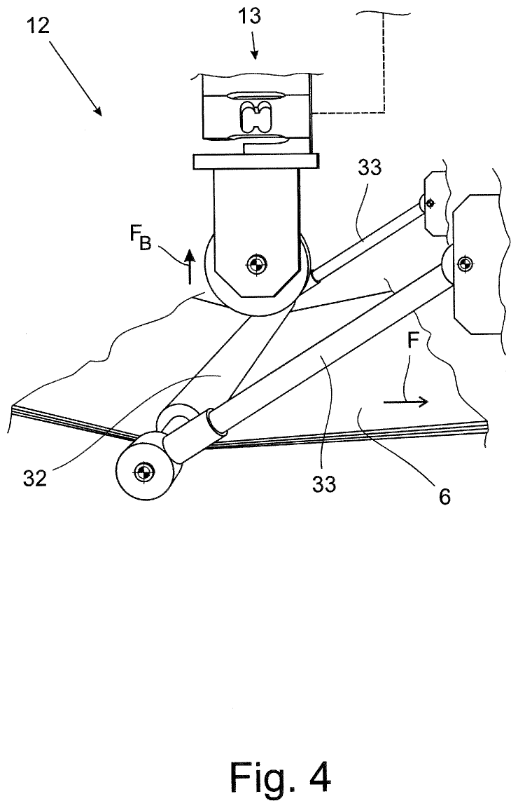

FIG. 4 shows a force-measuring assembly in a perspective lateral view; and

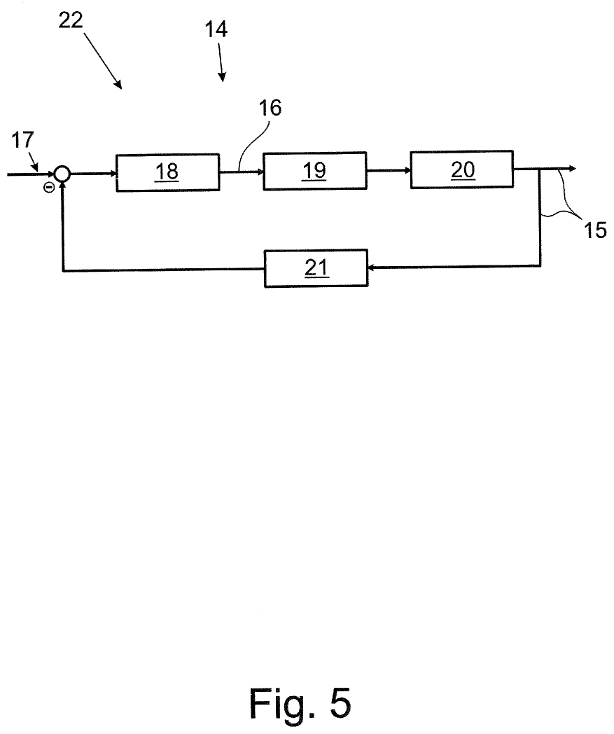

FIG. 5 shows the feedback-control concept according to the proposal as a feedback-control loop.

FIG. 1a) shows an aircraft 1 having structural aircraft components 2. In the fragment of FIG. 1a), formers 2a and stringers 2b are shown as such structural aircraft components 2, for example. Nowadays, these structural aircraft components 2 are also produced as fiber-reinforced components from fiber-reinforced plastics.

The device 3 according to the proposal and illustrated in FIG. 2 serves for processing fiber-reinforced plastics. The device 3 serves in particular for producing structural aircraft components 2 such as formers 2a and stringers 2b, or preforms therefor.

The device 3 here has at least two functional units 4. One of these functional units 4 is an infeed unit 5 for feeding a fiber scrim web 6. The fiber scrim web 6 presently and preferably is composed of a fibrous material bonded with thermoplastics powder, and is thus composed of a fiber-matrix semifinished product which is also referred to as a prepreg. The fiber scrim web 6 presently and preferably is composed of a plurality of layers.

As is illustrated in FIG. 2, it can be provided that these layers in the infeed unit 5 are first placed on top of one another so as to form the fiber scrim web 6. In this case, four layers from the supply rolls 7 illustrated are placed on top of one another so as to form the fiber scrim web 6. Alternatively, the fiber scrim web 6 can however also be already prefabricated and be fed from a single supply roll 7, or from another device, for example.

The functional units 4 furthermore comprise a processing unit 8 for processing the fiber scrim web 6. Examples of a processing unit 8 of this type will yet be mentioned hereunder. However, it is important here that this processing unit 8 acts on the fiber scrim web 6, the latter extending from the infeed unit 5 to the processing unit 8. The fiber scrim web 6 can also be cut in the further course of the device 3, but the cut parts of the fiber scrim web 6 in this instance are no longer part of the fiber scrim web 6. The fiber scrim web 6 is thus integral along a conveying direction F of the device 3.

The device 3 has a primary drive 9 for driving the fiber scrim web 6. The fiber scrim web 6 is pulled and/or pushed through the device 3 by means of this primary drive 9.

The device 3 furthermore has a control assembly 10 for controlling or feedback-controlling the primary drive 9.

It now is essential that the device 3 has at least one secondary drive 11 for driving the fiber scrim web 6. The secondary drive 11 in FIG. 2 is illustrated so as to be in front of the primary drive 9 in the conveying direction, but the sequence is fundamentally arbitrary.

It is furthermore essential that the device 3 has a force-measuring assembly 12, assigned to the secondary drive 11, having a force sensor 13 for measuring a web tension of the fiber scrim web 6 by means of the control assembly 10. In principle, the force sensor 13 can be an arbitrary force sensor 13. The preferred design embodiment of the force-measuring assembly 12 is yet to be explained hereunder. This force sensor 13 presently and preferably measures a force F_{B} which is a function of the web tension.

It is likewise essential that the control assembly 10 actuates the secondary drive 11 in a feedback-control routine; that the feedback-control routine comprises a secondary feedback-control loop 14 for feedback-controlling the secondary drive 11; that the control assembly 10 in the feedback-control routine feeds the web tension measured by the force-measuring assembly 12 assigned to the secondary drive 11 as an actual value 15 to the secondary feedback-control loop 14 and, based on the web tension, determines and sets a correcting variable 16 of the secondary drive 11. The term “web tension” here is to be understood so broadly that the latter also comprises a force F_{B} which is a function of the web tension. The web tension does not have to be actually calculated or determined in the strict sense.

The secondary feedback-control loop 14 is illustrated in FIG. 5. The secondary feedback-control loop 14 here can be constructed as follows. A command variable 17, which may emanate from a superordinate rotating speed controller and/or from a user specification, is presently and preferably predefined from the left in FIG. 5. Behind the summation point, which is yet to be explained, the control deviation is fed into a feedback controller 18 which therefrom generates a correcting variable 16. The secondary drive 11 presently and preferably is actuated by means of this correcting variable 16. This correcting variable 16 presently and preferably is the motor current of the secondary drive 11. The electrical part 19 of the secondary drive 11, which converts the motor current into a torque, in physical terms then follows in the feedback-control loop 14. This torque is applied to the fiber scrim web 6 by a mechanical part 20 of the secondary drive 11. The returning branch of the secondary feedback-control loop 14 is initiated by the measurement of the actual value 15 by the force-measuring assembly 12. The web tension as an actual value 15 is then converted in a further feedback controller 21 and in the summation point subtracted from the command variable 17.

Presently and preferably, the web tension is feedback-controlled by way of the secondary drive 11. The correcting variable 16 of the secondary feedback-control loop 14 and/or of the secondary drive 11 presently and preferably is the motor current or the torque. Alternatively, the torque or the rotating speed of the secondary drive 11 can be feedback-controlled. In this case, it is thus provided that the control assembly 10 in the feedback-control routine feeds the web tension measured by the force-measuring assembly 12 assigned to the secondary drive 11 as an actual value 15 to the secondary feedback-control loop 14 and, based on the web tension, determines and sets the torque or the rotating speed of the secondary drive 11 as the correcting variable 16 of the latter.

Of course, further bifurcations of the secondary feedback-control loop 14, monitors and the like, are also possible.

Differing from what is illustrated, the control assembly 10 illustrated in FIGS. 2 and 3 can also be a multiple-part control assembly 10. It can also be provided here that the primary drive 9 and the secondary drive 11 have in each case a dedicated control assembly, said control assemblies not having to communicate with each other. Nevertheless, said control assemblies are presently combined so as to form the control assembly 10. An overall control unit is preferably provided in a computer, for example.

It can be provided that the device 3 has a further force-measuring assembly 12, assigned to the primary drive 9, having a force sensor 13 for measuring a web tension of the fiber scrim web 6 by means of the control assembly 10. The force-measuring assembly 12, which is assigned to the primary drive 9, is presently and preferably designed so as to be substantially identical to the force-measuring assembly 12 which is assigned to the secondary drive 11. All explanations pertaining to the force-measuring assembly 12, which is assigned to the secondary drive 11, may also apply to this force-measuring assembly 12 and to all further force-measuring assemblies 12 yet to be mentioned.

It can be provided that the control assembly 10 actuates the primary drive 9 in the feedback-control routine, and that the feedback-control routine comprises a primary feedback-control loop 22 for feedback-controlling the primary drive 9. All explanations pertaining to the secondary feedback-control loop 14 presently and preferably apply likewise to the primary feedback-control loop 22. For this reason, the feedback-control loop shown in FIG. 5 is representative for the primary feedback-control loop 22, the secondary feedback-control loop 14, and all further feedback-control loops yet to be mentioned.

Accordingly, it is presently and preferably the case that the control assembly 10 in the feedback-control routine feeds the web tension measured by the force-measuring assembly 12 assigned to the primary drive 9 as an actual value 15 to the primary feedback-control loop 22 and, based on the web tension in the primary feedback-control loop 22, determines and sets a correcting variable 16 of the primary drive 9. It is even provided presently and preferably that the primary drive 9 and the secondary drive 11 are substantially identical and in terms of hierarchy are of equal standing.

The device 3 presently and preferably has at least one further secondary drive 11. The device 3 can have a further force-measuring assembly 12, assigned to the further secondary drive 11, having a force sensor 13 for measuring a web tension of the fiber scrim web 6 by means of the control assembly 10. It can be provided in this instance that the control assembly 10 actuates the further secondary drive 11 in the feedback-control routine; that the feedback-control routine comprises a further secondary feedback-control loop 14 for feedback-controlling the further secondary drive 11; that the control assembly 10 in the feedback-control routine feeds the web tension measured by the force-measuring assembly 12, assigned to the further secondary drive 11, as an actual value 15 to the further secondary feedback-control loop 14 and, based on the web tension in the further secondary feedback-control loop 14, determines and sets a correcting variable 16 of the further secondary drive 11. All explanations pertaining to the first secondary drive 11, to the assigned force-measuring assembly 12, and to the secondary feedback-control loop 14 apply here in an analogous manner. The device 3 preferably has two further secondary drives 11, preferably three further secondary drives 11, even furthermore preferably four further secondary drives 11, and/or at least two further secondary drives 11.

With a view to FIG. 2, the following functional units 4 may be provided. Provided presently and preferably is a compacting unit 23 for compressing the fiber scrim web 6. This compacting unit 23 presently and preferably serves for mutually compressing the layers of the fiber scrim web 6. The functional units 4 presently and preferably furthermore comprise a heating unit 24 for heating, in particular for adhesively bonding, the fiber scrim web 6. It can be provided here that a bonding agent of the fiber scrim web 6 is already contained in the latter, or is applied in the device 3. A heating unit 24 presently and preferably is disposed behind a compacting unit 23 in the conveying direction.

The functional units 4 presently and preferably comprise a transverse forming unit 25 for forming the fiber scrim web 6 in a direction transverse to the conveying direction F. A transverse forming unit 25 of this type serves for establishing T-profiles and U-profiles, for example. Accordingly, the device 3 presently and preferably serves for producing T-profiles and/or U-profiles. Therefore, the preforms producible are presently and preferably T-profiles and/or U-profiles.

It can furthermore be provided that the functional units 4 comprise a cutting unit 26 for cutting the fiber scrim web 6. The fiber scrim web 6 ends after the cutting unit 26. It can furthermore be provided that the functional units 4 comprise a longitudinal forming unit 27 which serves for forming the fiber scrim web 6, or as is illustrated in FIG. 2, pieces 28 of the fiber scrim web 6, in a direction along the conveying direction F.

It is presently and preferably provided that the fiber scrim web 6 is a layer construction from at least two layers of fiber-reinforced plastic that are disposed on top of one another. The fiber-reinforced plastic presently and preferably is a carbon fiber-reinforced plastic (CFRP) or a glass fiber-reinforced plastic (GFRP).

As is likewise illustrated in FIG. 2, the functional units 4 presently and preferably comprise a first heating unit 29 for first, in particular partial, adhesive bonding of the layers to one another. This partial adhesive bonding presently and preferably is adhesive bonding of the peripheries along the conveying direction F. The functional units 4 can comprise a second heating unit 30 for second, in particular complete, adhesive bonding of the layers to one another. In this case, the second heating unit 30 is preferably disposed at the end of the device 3, and at that location adhesively bonds the longitudinally reformed pieces 28 of the fiber scrim web 6. A preform is presently and preferably created as a result.

As has already been mentioned, the device 3 has a conveying direction F of the fiber scrim web 6. The second heating unit 30 presently and preferably is disposed behind the first heating unit 29 in the conveying direction F. It can be furthermore provided that the primary drive 9 and/or at least one secondary drive 11, along the conveying direction F, are/is disposed between the first and the second heating unit 29, 30.

The disposal of the drives 9, 11 in the device 3 is preferably chosen in such a manner that at least one functional unit 4, presently and preferably a processing unit 8, is disposed between the primary drive 9 and the secondary drive 11. Additionally or alternatively, it can be provided that at least one functional unit 4, presently and preferably a processing unit 8, is disposed between the secondary drive 11 and the further secondary drive 11. At least one functional unit 4, presently and preferably a processing unit 8, is in each case preferably disposed between the drives 9, 11.

Accordingly, the drives 9, 11 can be placed at critical locations within the device 3.

The schematic construction of the drives 9, 11 can be derived from FIG. 3. The primary drive 9 and/or the secondary drive 11 and/or the respective further secondary drive 11 presently and preferably have/has a drive roller 31 for driving the fiber scrim web 6. The drive roller 31 can exert a tensile force and/or a compressive force on the fiber scrim web 6. Said drive roller 31 presently and preferably transmits the torque from the respective drive 9, 11 to the fiber scrim web 6. It is particularly preferably the case that the drive roller 31 has a casing or a surface from an elastic material, in particular a foam material, or a sponge rubber, or a rubber or silicone or polyurethane. Layer materials, and in particular fiber-reinforced plastics materials, most particularly those that are not yet completely adhesively bonded, may have fluctuations in terms of their thickness. These fluctuations can be readily compensated by means of the elastic material.

With a view to FIG. 4, the preferred embodiment of the force-measuring assembly 12 will now be explained. The force sensor 13 in the conveying direction F presently and preferably is disposed behind the assigned drive 9, 11. Presently and preferably this relates to the force sensor 13 assigned to the secondary drive 11 and/or to the force sensor 13 assigned to the primary drive 9 and/or to all force sensors 13 of the drives 9, 11 according to the proposal. Additionally or alternatively, presently and preferably the corresponding force sensor 13, preferably the force sensor 13 assigned to the secondary drive 11, and/or the respective force sensor 13, are/is disposed in front of the functional unit 4 that in the conveying direction F follows the assigned drive 9, 11, in particular the secondary drive 11. In an embodiment not shown but likewise preferred, the force sensor 13 in the conveying direction F is disposed in front of the respective assigned drive 9, 11. Additionally or alternatively, the corresponding force sensor 13, preferably the force sensor 13 assigned to the secondary drive 11, and/or the respective force sensor 13 in this instance are/is presently and preferably disposed behind the functional unit 4 that in the conveying direction F is disposed in front of the assigned drive 9, 11, in particular the secondary drive 11.

The term “force sensor” here is to be broadly understood. Said force sensor may also comprise a plurality of sensors in the strict sense; it is important that the force sensor 13 measures the force at one location, as is illustrated. Force values thus cannot be measured at a plurality of mutually spaced-apart locations using one force sensor 13. The force sensor 13 presently and preferably comprises one or a plurality of piezo elements.

The force-measuring assembly 12 presently and preferably has a deflection roller 32 on which the fiber scrim web is deflected. The maximum deflection of the fiber scrim web 6, in particular in a layer construction, is preferably less than 90 degrees, furthermore preferably less than 60 degrees, even more preferably less than 45 degrees, yet more preferably less than 30 degrees, still furthermore preferably less than 20 degrees. It has been demonstrated that an intense deflection can lead to a delamination of the layers.

The deflection roller 32 presently and preferably is flexibly mounted. The deflection roller 32 presently and preferably is pivotably mounted. The deflection roller 32 here is mounted so as to be flexible in such a manner that a deflection of the deflection roller 32 is a function of the web tension. However, this deflection here is preferably less than 1 cm, furthermore preferably less than 1 mm.

As is illustrated in FIG. 4, the deflection roller 32 presently and preferably is mounted transversely to the conveying direction F on two sides, in particular by means of in each case one lever arm 33 which is in each case pivotably mounted on the remaining part of the device 3.

Presently and preferably it is the case that the deflection roller 32 is flexibly mounted transversely to the conveying direction F on the two sides and, therefore, is deflectable in a mutually independent manner on both sides. As can be seen from FIG. 4, owing to the rigid deflection roller 32, this independence is present only to a minor extent.

The force sensor 13 presently and preferably measures the deflection of the deflection roller 32. The force sensor 13 preferably engages on the deflection roller 32 on a side that faces away from the fiber scrim web 6. Alternatively, the fiber scrim web 6 can be disposed between the deflection roller 32 and the force sensor 13.

As illustrated, presently and preferably the force sensor does not engage directly on the deflection roller 32, but rather via a compression roller 32a.

The force sensor 13 presently and preferably engages transversely to the conveying direction F, in a range between 20% and 80% of the extent of the deflection roller 32 transverse to the conveying direction F. Furthermore preferably, the force sensor 13 engages in a range between 30% and 70% of the extent of the deflection roller 32 transverse to the conveying direction F, even furthermore preferably between 40% and 60% of the extent of the deflection roller 32 transverse to the conveying direction F. The force-measuring assembly 12 presently and preferably has exactly one force sensor 13 of this type, the latter potentially being correspondingly sufficient for measuring the web tension with adequate accuracy. This variant is preferable because a high level of stiffness in the direction transverse to the conveying direction F is provided in particular in the fiber-reinforced, preferably carbon fiber-reinforced plastics. This applies most particularly when the peripheries of the layers are already connected to one another. This one force sensor 13 presently and preferably engages so as to be substantially centric on the deflection roller 32.

It is presently and preferably provided for controlling the device 3 that the control assembly 10 synchronizes the drives 9, 11 in a superordinate synchronization routine. In the process, the command variables 17 of the feedback-control loops 14, 22 are preferably synchronized in the synchronization routine. As a result, homogenous controlling or feedback-controlling of the web tension can be achieved.

Proposed according to a further teaching, which is of independent relevance, is a device 3 for processing layer constructions, in particular for producing structural aircraft components 2 or preforms therefor. These layer constructions here can fundamentally comprise arbitrary materials. The materials presently and preferably are lightweight construction materials.

This device 3 here can be partially or completely designed like the device 3 previously described. This device 3 also has at least two functional units 4, the functional units 4 comprising at least one infeed unit 5 for feeding a layer web, and a processing unit 8 for processing the layer web. The device 3 furthermore has a primary drive 9 for driving the layer web, and a control assembly 10 for controlling or feedback-controlling the primary drive 9. The layer web is composed of at least two material layers, thus forming a layer construction. Said layer web is composed in particular of two layers of a lightweight construction material, preferably glass fiber-reinforced plastic or carbon fiber-reinforced plastic.

It is essential in this further device 3 that the device 3 has at least one secondary drive 11 for driving the layer web; that the device 3 has a force-measuring assembly 12, assigned to the secondary drive 11, having a force sensor 13 for measuring a web tension of the layer web by means of the control assembly 10; that the control assembly 10 actuates the secondary drive 11 in a feedback-control routine; that the feedback-control routine comprises a secondary feedback-control loop 14 for feedback-controlling the secondary drive 11; that the control assembly 10 in the feedback-control routine feeds the web tension measured by the force-measuring assembly 12 assigned to the secondary drive 11 as an actual value 15 to the secondary feedback-control loop 14 and, based on the web tension in the secondary feedback-control loop 14, determines and sets a correcting variable 16 of the secondary drive 11; that the force-measuring assembly 12 has a deflection roller 32 on which the layer web is deflected; that the deflection roller 32 is mounted so as to be flexible in such a manner that a deflection of the deflection roller 32 is a function of the web tension; and that the force sensor 13 measures the deflection of the deflection roller 32.

Reference may be made to all explanations pertaining to the device 3 according to the proposal of the first teaching.

It has been recognized here that the force-measuring assembly 12 according to the proposal is not only relevant for fiber-reinforced plastics. The control assembly 10 according to the proposal in this further teaching also is of high relevance.

Proposed according to a further teaching, which is likewise of independent relevance, is the use of a device 3 according to one of the first two teachings, for processing fiber-reinforced plastic, in particular carbon fiber-reinforced plastic or glass fiber-reinforced plastic, preferably for producing structural aircraft components 2 or preforms therefor. Reference may be made to all explanations pertaining to the devices 3 according to the proposal.

Proposed according to a further teaching, which is likewise of independent relevance, is a method for controlling a device 3 according to one of the first two teachings. It is essential here that the control assembly 10 carries out the feedback-control routine. Reference may be made to all explanations pertaining to the devices 3 according to the proposal and the use thereof.

1. A device for processing fiber-reinforced plastic, in particular for producing structural aircraft components (2) or preforms therefor, having at least two functional units (4), the functional units (4) comprising at least one infeed unit (5) for feeding a fiber scrim web (6), and a processing unit (8) for processing the fiber scrim web (6);
having a primary drive (9) for driving the fiber scrim web (6);
having a control assembly (10) for controlling or feedback-controlling the primary drive (9), characterized in that
the device (3) has at least one secondary drive (11) for driving the fiber scrim web (6);
in that the device (3) has a force-measuring assembly (12) assigned to the secondary drive (11), having a force sensor (13) for measuring a web tension of the fiber scrim web (6) by means of the control assembly (10);
in that the control assembly (10) actuates the secondary drive (11) in a feedback-control routine; in that the feedback-control routine comprises a secondary feedback-control loop (14) for feedback-controlling the secondary drive (11); in that the control assembly (10) in the feedback-control routine feeds the web tension measured by the force-measuring assembly (12) assigned to the secondary drive (11) as an actual value (15) to the secondary feedback-control loop (14) and, based on the web tension in the secondary feedback-control loop (14), determines and sets a correcting variable (16) of the secondary drive (11).

2. The device as claimed in claim 1, characterized in that the device (3) has a further force-measuring assembly (12), assigned to the primary drive (9), having a force sensor (13) for measuring a web tension of the fiber scrim web (6) by means of the control assembly (10); in that the control assembly (10) actuates the primary drive (9) in the feedback-control routine; in that the feedback-control routine comprises a primary feedback-control loop (22) for feedback-controlling the primary drive (9); in that the control assembly (10) in the feedback-control routine feeds the web tension measured by the force-measuring assembly (12) assigned to the primary drive (9) as an actual value (15) to the primary feedback-control loop (22) and, based on the web tension in the primary feedback-control loop (22), determines and sets a correcting variable (16) of the primary drive (9).

3. The device as claimed in claim 1 or 2, characterized in that the device (3) has at least one further secondary drive (11); in that the device (3) has a further force-measuring assembly (12), assigned to the further secondary drive (11), having a force sensor (13) for measuring a web tension of the fiber scrim web (6) by means of the control assembly (10); in that the control assembly (10) actuates the further secondary drive (11) in the feedback-control routine; in that the feedback-control routine comprises a further secondary feedback-control loop (14) for feedback-controlling the further secondary derive (11); in that the control assembly (10) in the feedback-control routine feeds the web tension measured by the force-measuring assembly (12) assigned to the further secondary drive (11) as an actual value (15) to the further secondary feedback-control loop (14) and, based on the web tension in the further secondary feedback-control loop (14), determines and sets a correcting variable (16) of the further secondary drive (11).

4. The device as claimed in one of the preceding claims, characterized in that the functional units (4) comprise a compacting unit (23) for compressing the fiber scrim web (6), and/or in that the functional units (4) comprise a heating unit (24) for heating, in particular for adhesively bonding, the fiber scrim web (6), and/or in that the functional units (4) comprise a transverse forming unit (25) for forming the fiber scrim web (6) in a direction transverse to a conveying direction (F), and/or in that the functional units (4) comprise a cutting unit (26) for cutting the fiber scrim web (6), and/or in that the functional units (4) comprise a longitudinal forming unit (27) for forming the fiber scrim web (6), or pieces of the fiber scrim web (6), in a direction along the conveying direction (F).

5. The device as claimed in one of the preceding claims, characterized in that the fiber scrim web (6) is a layer construction from at least two layers of fiber-reinforced plastic, in particular carbon fiber-reinforced plastic or glass fiber-reinforced plastic, disposed on top of one another.

6. The device as claimed in claim 5, characterized in that the functional units (4) comprise a first heating unit (29) for first, in particular partial, adhesive bonding of the layers to one another; in that the functional units (4) comprise a second heating unit (30) for second, in particular complete, adhesive bonding of the layers to one another; in that the second heating unit (30) in the conveying direction (F) is disposed behind the first heating unit (29), preferably in that the primary drive (9) and/or at least one secondary drive (11) are/is disposed between the first and the second heating unit (29, 30).

7. The device as claimed in one of the preceding claims, characterized in that at least one functional unit (4) is disposed between the primary drive (9) and the secondary drive (11), and/or in that at least one functional unit (4) is disposed between the secondary drive (11) and the further secondary drive (11), preferably in that at least one functional unit (4) is in each case disposed between the drives (9, 11).

8. The device as claimed in one of the preceding claims, characterized in that the primary drive (9) and/or the secondary drive (11) and/or the respective further secondary drive (11) have/has a drive roller (31) for driving the fiber scrim web (6); in that the drive roller (31) exerts a tensile force and/or compressive force on the fiber scrim web (6), preferably in that the drive roller (31) has a casing or a surface from an elastic material, in particular a foam material.

9. The device as claimed in one of the preceding claims, characterized in that the force sensor (13), preferably the force sensor (13) assigned to the secondary drive (11), and/or the respective force sensor (13), in the conveying direction (F) are/is disposed in front of or behind the assigned drive (9, 11), in particular the secondary drive (11), and/or in that the force sensor (13), preferably the force sensor (13) assigned to the secondary drive (11), and/or the respective force sensor (13), are/is disposed in front of the functional unit (4) that in the conveying direction (F) follows the assigned drive (9, 11), in particular the secondary drive (11).

10. The device as claimed in one of the preceding claims, characterized in that the force-measuring assembly (12) has a deflection roller (32) on which the fiber scrim web (6) is deflected, preferably in that the deflection roller (32) is mounted so as to be flexible, in particular pivotable, in such a manner that a deflection of the deflection roller (32) is a function of the web tension, furthermore preferably in that the deflection roller (32), transversely to the conveying direction (F), is flexibly mounted on two sides and on both sides is able to be deflected in a mutually independent manner.

11. The device as claimed in claim 10, characterized in that the force sensor (13) measures the deflection of the deflection roller (32), preferably in that the force sensor (13) engages on the deflection roller (32) on a side that faces away from the fiber scrim web (6), and/or in that the force sensor (13) engages in a range between 20% and 80% of the extent of the deflection roller (32) transverse to the conveying direction (F), furthermore preferably between 30% and 70% of the extent of the deflection roller (32) transverse to the conveying direction (F), even furthermore preferably between 40% and 60% of the extent of the deflection roller (32) transverse to the conveying direction (F), preferably in that the force-measuring assembly (12) has exactly one force sensor (13).

12. The device as claimed in one of the preceding claims, characterized in that the control assembly (10) synchronizes the drives (9, 11) in a superordinate synchronization routine, preferably in that command variables (17) of the feedback-control loops (14, 22) are synchronized in the synchronization routine.

13. A device for processing layer constructions, in particular for producing structural aircraft components (2) or preforms therefor,
having at least two functional units (4), the functional units (4) comprising at least one infeed unit (5) for feeding a layer web, and a processing unit (8) for processing the layer web,
having a primary drive (9) for driving the layer web,
having a control assembly (10) for controlling or feedback-controlling the primary drive (9), characterized in that
the device (3) has at least one secondary drive (11) for driving the layer web;
in that the device (3) has a force-measuring assembly (12), assigned to the secondary drive (11), having a force sensor (13) for measuring a web tension of the layer web by means of the control assembly (10);
in that the control assembly (10) actuates the secondary drive (11) in a feedback-control routine; in that the feedback-control routine comprises a secondary feedback-control loop (14) for feedback-controlling the secondary drive (11); in that the control assembly (10) in the feedback-control routine feeds the web tension measured by the force-measuring assembly (12) assigned to the secondary drive (11) as an actual value (15) to the secondary feedback-control loop (14) and, based on the web tension in the secondary feedback-control loop (14), determines and sets a correcting variable (16) of the secondary drive (11); in that the force-measuring assembly (12) has a deflection roller (32) on which the layer web is deflected; in that the deflection roller (32) is mounted so as to be flexible in such a manner that a deflection of the deflection roller (32) is a function of the web tension; and
in that the force sensor (13) measures the deflection of the deflection roller (32).

14. The use of a device (3) as claimed in one of the preceding claims for processing fiber-reinforced plastic, in particular carbon fiber-reinforced plastic or glass fiber-reinforced plastic, preferably for producing structural aircraft components (2) or preforms therefor.

15. A method for controlling a device (3) as claimed in one of claims 1 to 13, characterized in that the control assembly (10) carries out the feedback-control routine.
